(19) United States
(12) Patent Application Publication
(10) Pub. No.: US 2011/0234413 A1
(43) Pub. Date: Sep. 29, 2011

(54) GRIP RESPONSIVE SLEEP ALERT SYSTEM AND METHOD

(76) Inventor: Donald Dobbs, Kendall, FL (US)

(21) Appl. No.: 12/915,597

(22) Filed: Oct. 29, 2010

Related U.S. Application Data
(60) Provisional application No. 61/317,482, filed on Mar. 25, 2010.

(51) Int. Cl. G08B 23/00

(52) U.S. Cl. 340/575

(57) ABSTRACT

The present invention is related to a grip responsive sleep alert system, comprising a housing, including a trigger mechanism electrically connected to a first electrical contact, and a second electrical contact attached to the housing and connected to a battery and to an audible alert device. The first and second electrical contacts are normally in contact between each other, such that the first electrical contact secured to the trigger mechanism is in contiguous communication with the second electrical contact attached to the housing in a normal configuration. Upon activation of the trigger mechanism and separation of the first electrical contact relative to the second electrical contact effects disengagement and deactivation of the audible alarm, whereupon fatigue permits the first electrical contact and the second electrical contact to actuate the audible alarm to alert an individual at an onset of sleep.

### CROSS-REFERENCE TO RELATED APPLICATION

This application claims the benefit of co-pending U.S. Provisional Patent Application Ser. No. 61/317,482, filed on Mar. 25, 2010, which is incorporated herein in its entirety.

### BACKGROUND OF THE INVENTION

1. Field of the Invention

The present invention relates generally to a sleep-preventing alarm system. The invention is, however, more particularly directed to a grip responsive sleep alert system and method, for providing an audible alert to preclude a driver of a motor vehicle or any other user from falling asleep with a sleep-preventing alarm.

2. Description of the Prior Art

Driver fatigue and falling asleep at the wheel is a major cause of car crashes. Fatigue can be very difficult to identify as the source of accidents because estimates are made based almost solely on police reports, and driver statements. Estimates are that 10-20% of fatal accidents and about 5 to 10% of all car accidents may be related to tired drivers.

According to the National Highway Traffic Safety Administration, there may be as many as 100,000 crashes from driver fatigue each year, with an estimated 1,550 deaths, 71,000 people injured, causing $12.5 billion economic losses. These figures may be the tip of the iceberg, since currently it is difficult to attribute crashes to sleepiness.

In accordance with a recent survey, more than 10 percent of drivers admit to having fallen asleep at the wheel, while more than 20 percent say they have momentarily dozed while driving, according to a study of 1,024 drivers. Referred to as “the silent killer” because it is so often overlooked as the cause of an accident, drowsy driving's full effect is not yet known because reporting is imprecise, police are not trained to detect sleep-related crashes and there is no device to determine whether someone was driving while dangerously drowsy.

Some of the tactics drivers resort to in an effort to fight drowsiness on the road are, in descending order, stop driving or switch drivers, open the windows or turn on the air conditioning, listen to the radio or CDs, stop eating or drinking, drink caffeine, among others.

Another method drivers have used to stay awake at the wheel include talking or singing to themselves, splashing water in their faces and slapping, hitting, or pinching themselves.

Sleep deprivation is a common problem not only for car drivers but also among airline pilots and other workers who are required to perform any type of tasks over a prolonged period of time. Just as an example, on Mar. 4, 2004, a commercial pilot and his first officer fell asleep while approaching Denver International Airport in an A319 Airbus jet, going twice the speed as allowed, according to a report from the Federal Aviation Administration (FAA).

Loss of sleep and fatigue in these settings can significantly impair cognitive function, and can lead to dangerous decrements in human performance. In particular, falling asleep at the controls of a commercial vehicle such as a truck, tanker, or airplane can lead to potentially catastrophic consequences. Besides the transportation context, drastic consequences may result by an operator falling asleep at the controls of a nuclear power plant, an electrical power grid, or other system that could impact many lives.

There are several patents in the prior art related to devices and methods for providing an audible alert to the user. For example, a sleep alert apparatus adapted to be worn upon the head of the operator of a transportation vehicle, including a baseball-type cap, a flexible pouch attached to the exterior surface of a side portion of the cap, an upwardly directed entrance opening, and a tilt monitoring device removably inserted into the pouch. The tilt monitoring device includes a housing confining a gravity activated switch, a noise generator, and a battery power source.

Another example is a fatigue alarm comprising a housing, with the housing including a first fixed handle plate extending from the housing and a second movable handle plate separated from the first handle plate in a biased separation relative to one another, such that a first electrical contact secured to the second handle plate within the housing is in contiguous communication with a second electrical contact within the housing in a normal configuration, such that upon separation of the first electrical contact relative to the second electrical contact against a spreader member within the housing effects disengagement and deactivation of an audible alarm, whereupon fatigue permits movement of the second handle plate away from the first handle plate to engage the first electrical contact and the second electrical contact to actuate the audible alarm to alert an individual at an onset of sleep.

There is also an apparatus known which decides the presence or absence of an anomaly by detecting the gripped state of a steering wheel by the driver steering a road vehicle, or by measuring fluctuations in the heart rate and heartbeat period of the driver, and which issues an alarm of “Take a rest”, etc. or control the vehicle speed to be lowered, if any anomaly occurs. A detecting means is attached to a steering wheel, steering wheel cover or a band-shaped member. The detecting means comprises a plurality of reflection type optical sensors, which are each composed of a light emitting element and one or lighter receiving elements, and which are set in such proper arrangement and orientation as to permit detection in any of various conditions.

An alarm system formed by a wrapper includes an energy source, an operator grip pressure controlled switch, an orientation responsive switch, and an audio resonator is also known. The wrapper is secured to an operator controllable member, such as a steering wheel, by being folded over the member upon itself and secured using, for example, a fabric fastener interlock. In operation, the user places his/her hand upon the pressure control switch included within the wrapper. When the grip of the user becomes relaxed, for example, due to inattention or fatigue, the switch operates the resonator and an alarm is sounded. The orientation responsive switch controls disablement and enablement of the alarm system in response to displacement of the operator controllable member.

Another grip responsive alert system includes a pressure sensor associated with a mechanism for controlling a vehicle. The pressure sensor detects operator fatigue as exhibited by a change in operator pressure on the control mechanism. An operator stimulus is coupled to the pressure sensor and, upon sensing fatigue, produces a stimulus such as a visual or audible alarm whereby alertness of the operator is maintained.

The above cited solutions are basically focused on waking the driver, but this is not an appropriate solution to this serious problem. Just as an example, a vehicle traveling at 60 miles per hour (MPH) goes 88 ft. per second, almost a football field every 4 seconds. Sleep must be prevented instead of waking a driver.

Those devices for detecting the movement of the driver's head involve a delay needed to run the process that it is not acceptable. Every road has a crown for water runoff. On a common one lane each way road, the crown is in the middle, therefore when the driver falls asleep, the vehicle is directed to steer slightly left. Every vehicle has the front wheel geometry adjusted to causing the vehicle to travel in a straight line when there is no driver physical input. That would be fine if the driver only travels across two-lane roads. However, if the driver is on a four or more lane road, the steering geometry increases a left steering action, and a crossover accident may be imminent.

Even though the above cited systems and devices for awaking an operator address some of the needs of the market, an economical and simple sleep alert system to prevent the operator from falling asleep, may be used by different type of users, including car drivers, airline pilots, security personnel, among others, is still desired.

### SUMMARY OF THE INVENTION

It is therefore an object of the present invention to provide a grip responsive sleep alert system and method that are suited to keep an operator awake during a sensitive or dangerous operation, for example, driving a car, flying an aircraft, etc.

It is a further object of the present invention to provide an improved sleep detection and driver alert apparatus that utilizes a trigger-like mechanism that engages and disengages an audible alarm.

It is also a further object of the present invention to provide a grip responsive sleep alert system that determines changes in the operator attention via a relaxation of the muscles that hold the trigger mechanism open.

Yet an object of the present invention is to provide an improved grip responsive sleep alert system and method that can provide an audible alarm in order to awaken or alert a sleepy driver.

It is a further object of the present invention to provide an improved grip responsive sleep alert apparatus that it is possible to calibrate to assure proper operation with users of different sizes, strengths, and other physical characteristics.

Accordingly, it is a primary object of the present invention to provide an improved grip responsive sleep alert system defined by a portable device.

In summary, the present invention is related to a grip responsive sleep alert system comprising a housing including a trigger mechanism electrically connected to a first electrical contact, and a second electrical contact attached to the housing and connected to a battery and to an audible alert device. The first and second electrical contacts are normally in contact between each other, such that the first electrical contact secured to the trigger mechanism is in contiguous communication with the second electrical contact attached to the housing in a normal configuration. Upon activation of the trigger mechanism and separation of the first electrical contact relative to the second electrical contact effects disengagement and deactivation of an audible alarm, whereupon fatigue permits the first electrical contact and the second electrical contact to actuate the audible alarm to alert an individual at the onset of sleep.

These and other aspects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 is a schematic cross sectional view of the grip responsive sleep alert system in accordance with the present invention. This figure shows the trigger mechanism in its normal closed position; and

FIG. 2 illustrates schematically one possible embodiment of the electrical circuit of the present invention.

### DETAILED DESCRIPTION OF REPRESENTATIVE EMBODIMENTS

Shown throughout the Figures, the invention is directed to a grip responsive sleep alert system 10 comprising a housing 11 including a trigger mechanism 12. Said trigger mechanism 12 comprises a torsion spring 13 including two arms 14-15 connected to a spiral spring portion 16. The first arm 14 is fitted with a plastic movable handle 17, the second arm is fitted with a stationary holder 18 integral to the housing 11, and the circular spring portion 16 is mounted on a stationary fulcrum 19 also integral to the housing 11.

Said handle 17 includes a series of indentations 20 and an electrical contact 21. Into the same housing 11, a battery 22 and a buzzer 23 are also lodged. The positive terminal 24 of this battery 22 is electrically connected to a stationary connector 25 attached to the housing, and the negative terminal 29 to the negative terminal 30 of the buzzer 23. Moreover, the positive terminal 31 of the buzzer 23 is connected to the connector 21 of the handle 17.

The housing 11 may have different shapes, but in the illustrated embodiment the device includes a handle portion 30 that looks like a pistol handle and the handle 17 that looks like a gripper.

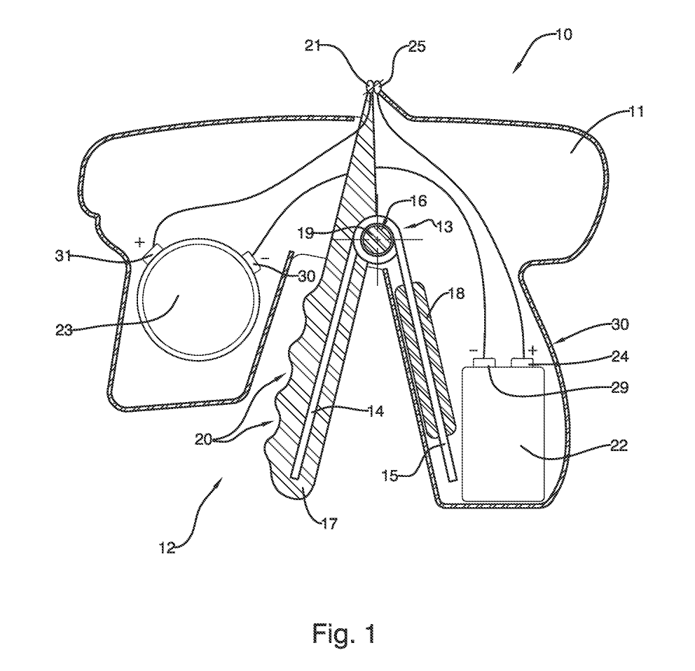

The device is in a normal closed position that means the buzzer is normally activated when the handle 17 is in its rest position like the one illustrated in FIG. 1. In order to avoid the activation of the buzzer when the user must perform some task in which both hands are needed (for example, paying a toll while driving, or going to the bathroom) a piece of paper, or a card may be inserted between both contacts 21-25.

The device will be activated when the user releases the trigger mechanism. When the user is, for example, driving he/she must squeeze the gripper formed between handle 17 and the handle portion 30 of the housing 11. By doing this, the electrical contacts 21-25 are kept separated. The lever 17 is rotated counterclockwise around the fulcrum 19, and the electrical contact 21 attached to this piece 17 rotates away from the stationary contact 25. By doing this the electrical circuit defined between the battery 22 and the audible alarm device or buzzer 23 is open, deactivated.

Different research demonstrated that one of the consequences of fatigue is the immediate relaxation of the muscular tension. Therefore, in this particular case, this relaxation will cause the user to release the handle 17 and thus the activation of the buzzer 23.

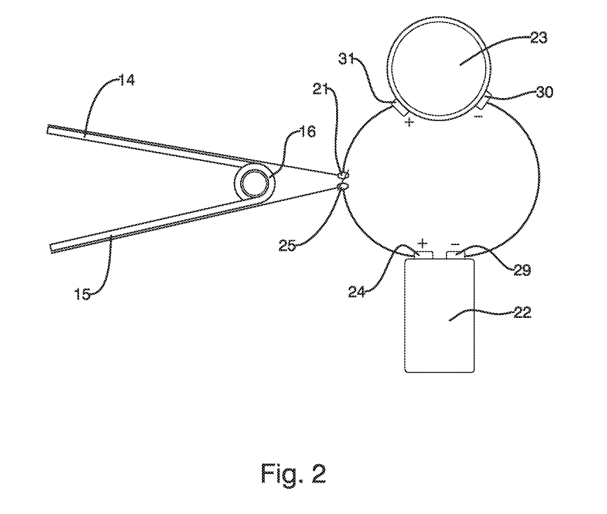

FIG. 2 illustrates schematically one possible embodiment of the electrical circuit of the present invention. The circuit includes a battery 22, electrical contacts 21-25, and an audible alarm device defined by a buzzer 23. These are just the basics of the circuit and many other elements may also be included, for example, adjusting means, sensibility means, etc.

It is also important to point out that the housing and the electrical contacts may have many different forms without departing from the main idea introduced by the present invention. For example, instead of having a gripper shape, the housing may have a pistol-like shape that the user must grab firmly for avoiding the alarm device being activated.

While the preferred embodiments of the invention have been described above, it will be recognized and understood that various modifications can be made in the invention, and the appended claims are intended to cover all such modifications which may fall within the spirit and scope of the invention.

I claim:

1. Grip responsive sleep alert system, comprising a normally-closed trigger mechanism electrically connected to a battery and to an audible alert device.

2. The grip responsive sleep alert system of claim 1, wherein the system also comprises a plastic hollow housing into which the trigger mechanism, the battery and the audible alert device are lodged.

3. The grip responsive sleep alert system of claim 2, wherein the trigger mechanism is electrically connected to a first electrical contact, and a second electrical contact attached to the housing and connected to the battery and to the audible alert device.

4. The grip responsive sleep alert system of claim 3, wherein the first and second electrical contacts are normally in contact between each other; the first electrical contact secured to the trigger mechanism is in contiguous communication with the second electrical contact attached to the housing.

5. The grip responsive sleep alert system of claim 2, wherein said trigger mechanism comprises a torsion spring, including two arms connected to a spiral spring portion.

6. The grip responsive sleep alert system of claim 5, wherein the first arm of said torsion spring is fitted with a plastic movable handle, the second arm is fitted with a stationary holder integral to the housing, and the circular spring portion is mounted on a stationary fulcrum integral to the housing.

7. The grip responsive sleep alert system of claim 6, wherein said handle includes a series of indentations.

8. The grip responsive sleep alert system of claim 6, wherein at the end of the plastic movable handle an electrical contact is included.

9. The grip responsive sleep alert system of claim 8, wherein the housing includes a stationary electrical contact.

10. The grip responsive sleep alert system of claim 9, wherein the positive terminal of said battery is electrically connected to the stationary connector of the housing, and the negative terminal of the battery to the negative terminal of the audible alert device, and the positive terminal of the audible alert device is connected to the electrical contact of the handle.

11. The grip responsive sleep alert system of claim 6, wherein the portion of the housing where the battery and the stationary holder have a pistol-like shape.

12. The grip responsive sleep alert system of claim 6, wherein the handle has a gripper-like shape.

13. The grip responsive sleep alert system of claim 1, wherein the audible alert device is a buzzer.

14. The grip responsive sleep alert system of claim 1, wherein the battery is a 9V battery.

15. The grip responsive sleep alert system of claim 1, wherein the battery is an AA-type battery.

16. The grip responsive sleep alert system of claim 1, wherein the battery is an AAA-type battery.

17. The grip responsive sleep alert system of claim 3, wherein the electrical contact between the trigger and the first electrical contact comprises an electrical wire.

18. The grip responsive sleep alert system of claim 3, wherein the second electrical contact between the housing and the battery and to the audible alert device comprises an electrical wire.

19. The grip responsive sleep alert system of claim 5, wherein the torsion spring is made of steel.

20. The grip responsive sleep alert system of claim 6, wherein the stationary fulcrum comprises an integral pin with the body of the housing.
